(19) United States
(12) Patent Application Publication
(10) Pub. No.: US 2022/0132859 A1
(43) Pub. Date: May 5, 2022

(54) METHODS AND APPARATUS FOR FORMING ANTIMICROBIAL FILM

(71) Applicant: APPLIED MATERIALS, INC., Santa Clara, CA (US)

(72) Inventors: Mukhles SOWWAN, Cupertino, CA (US); Samer BANNA, San Jose, CA (US)

(21) Appl. No.: 17/507,141

(22) Filed: Oct. 21, 2021

Related U.S. Application Data
(60) Provisional application No. 63/110,026, filed on Nov. 5, 2020.

(51) Int. Cl. A01N 59/20; C09D 1/00; C09D 5/14; C08L 23/06; C08L 23/12

(52) U.S. Cl. CPC A01N 59/20; C09D 1/00; C08L 23/12; C08L 23/06; C09D 5/14

(57) ABSTRACT

Methods and apparatus form antimicrobial films for sanitization of high touch surfaces. In some embodiments, an antimicrobial film includes a polymer layer with a first top surface and a bottom surface, at least one microstructure on the first top surface of the polymer layer with the microstructure having a second top surface, at least one nanostructure on the second top surface of the at least one microstructure with at least one nanostructure having an exposed surface, and an antimicrobial coating formed on the first top surface of the polymer layer, the second top surface of the at least one microstructure, and the exposed surface of the at least nanostructure. An adhesive layer is formed on the bottom surface to the polymer layer to allow the antimicrobial film to be applied to the high touch surfaces.

### CROSS-REFERENCE TO RELATED APPLICATIONS

This application claims benefit of U.S. provisional patent application Ser. No. 63/110,026, filed Nov. 5, 2020 which is herein incorporated by reference in its entirety.

### FIELD

Embodiments of the present principles generally relate to antimicrobial film.

### BACKGROUND

Coronavirus disease 2019 (COVID-19) is an infectious disease caused by severe acute respiratory syndrome coronavirus 2 (SARS-CoV-2). With cases reported in every country around the world, scientists are focused on understanding how coronavirus spreads to help people take the right steps to prevent the spread of the disease. To date, experts believe that SARS-COV-2 spreads mainly in two ways. First, through droplets—when infected people speak, cough, or sneeze, the infected people generate saliva droplets that vary in size, and some of the droplets might contain the SARS-COV-2 virus. Anyone who is within two meters of that person can breathe those floating droplets into their respiratory system and get infected. Second, through surface transmission—indirect contact with surfaces in the immediate environment of infected persons such as countertops, doorknobs, or computer screens, etc.

Accordingly, the inventors have provided methods and apparatus for forming antimicrobial film that may be applied to surfaces to guard against surface transmission of diseases, providing protection in a cost-effective manner.

### SUMMARY

Methods and apparatus for forming an antimicrobial film are provided herein.

In some embodiments, an antimicrobial film may comprise a polymer layer having a first side and second side, wherein the first side of the polymer layer includes at least one microstructure and at least one nanostructure on the at least one microstructure and an antimicrobial coating on the at least one microstructure and the at least one nanostructure.

In some embodiments, the antimicrobial film may also include wherein the antimicrobial coating is formed of copper, wherein the antimicrobial coating has a thickness of one or two monolayers of copper atoms, an adhesive layer applied to the second side of the polymer layer, wherein a thickness of the adhesive layer is greater than a thickness of the polymer layer, wherein the polymer layer is formed from polypropylene or polyethylene, wherein the at least one microstructure has a height of approximately 5 microns to approximately 10 microns above a first top surface of the first side of the polymer layer, wherein a second top surface of the at least one microstructure has a width of approximately 3 microns to 8 microns, wherein the at least one microstructure has a height of approximately 0.3 microns to approximately 3.0 microns above a first top surface of the first side of the polymer layer and a second top surface of the at least one microstructure has a width of approximately 5 microns, wherein the at least one nanostructure has a height of approximately 0.3 microns to approximately 3.0 microns above a second top surface of the at least one microstructure with an apex of approximately 100 nm or less, wherein a spacing between two or more of the at least one nanostructure is approximately 0.1 microns to approximately 1.0 microns, wherein the at least one nanostructure has a height of approximately 0.3 microns to approximately 3.0 microns above a second top surface of the at least one microstructure and a spacing between two or more of the at least one nanostructure is approximately 0.5 microns, and/or wherein the antimicrobial film is hydrophobic.

In some embodiments, a system for forming antimicrobial film may include an extruder configured to form a polymer film from polymer granules, a mold configured to imprint at least one microstructure and at least one nanostructure on a top surface of the polymer film after the polymer film is formed by the extruder, a deposition chamber configured to form an antimicrobial coating on the top surface of the polymer film, the at least one microstructure, and the at least one nanostructure, and a curing chamber configured to cure the polymer film.

In some embodiments, the system may further include an adhesive applicator configured to form adhesive on a bottom surface of the polymer film, wherein the antimicrobial coating is formed by deposition of one or two monolayers of copper atoms, and/or wherein the curing chamber is configured to use ultraviolet light to cure the polymer film.

In some embodiments, a method for forming antimicrobial film may include extruding granules of a polymer material to form a polymer base material, imprinting at least one structure on a top surface of the polymer base material using a rotating mold, wherein the at least one structure is a microstructure or a nanostructure, depositing an antimicrobial coating onto the at least one structure and the top surface of the polymer base material, and curing the polymer base material to form an antimicrobial film.

In some embodiments, the method may further include applying an adhesive to a bottom surface of the polymer base material, and/or wherein the antimicrobial coating consists of copper material.

Other and further embodiments are disclosed below.

### BRIEF DESCRIPTION OF THE DRAWINGS

Embodiments of the present principles, briefly summarized above and discussed in greater detail below, can be understood by reference to the illustrative embodiments of the principles depicted in the appended drawings. However, the appended drawings illustrate only typical embodiments of the principles and are thus not to be considered limiting of scope, for the principles may admit to other equally effective embodiments.

FIG. 1 depicts a cross-sectional view of an antimicrobial film in accordance with some embodiments of the present principles.

FIG. 2 depicts a cross-sectional view of a microstructure in accordance with some embodiments of the present principles.

FIG. 3 depicts a cross-sectional view of nanostructures in accordance with some embodiments of the present principles.

FIG. 4 depicts a cross-sectional view of a roll-to-roll production system for producing antimicrobial film in accordance with some embodiments of the present principles.

FIG. 5 is a method of producing antimicrobial film in accordance with some embodiments of the present principles.

To facilitate understanding, identical reference numerals have been used, where possible, to designate identical elements that are common to the figures. The figures are not drawn to scale and may be simplified for clarity. Elements and features of one embodiment may be beneficially incorporated in other embodiments without further recitation.

### DETAILED DESCRIPTION

The methods and apparatus provide a flexible antimicrobial film that prevents or substantially reduces the surface transmission of diseases. The antimicrobial film is manufactured in a cost-effective manner that allows for widespread use, providing another tool in the fight against the spread of diseases such as COVID-19 and many others. In some embodiments, the antimicrobial film uses antimicrobial copper/copper oxide coated hierarchical nano to micro-scale structures of adhesive polymer films (for example Polypropylene or Polyethylene). The antimicrobial films can be applied to high touch surfaces in hospitals, residential homes, consumer goods, public transportation, and parks, and the like.

Counteracting the spreading of diseases, such as the SARS-COV-2 virus, is currently among the highest priorities in public health policies. In a recent work published in the New England Journal of Medicine (Doremalen et al., 2020, Aerosol and Surface Stability of SARS-CoV-2 as Compared with SARS-CoV-1, N GNG J MED 382; 16), a team of researchers from the National Institute of Health (NIH), Princeton University, and the University of California investigated the stability of SARS-COV-2 virus on high-touch surfaces. The team found that the virus was detectable in droplets floating in air for up to 3 hours, detectable on copper surfaces for up to 4 hours, detectable on cardboard surfaces for up to 24 hours, and detectable on stainless-steel for up to 72 hours. The team's results highlight the potential of copper as an antiviral coating against the SARS-COV-2 virus and others.

In previous studies, the effect of copper has been tested against other viruses, bacteria, and fungi (Grass G., Rensing, C., and Solioz, M. (2011), Metallic copper as an antimicrobial surface, Appl. Environ. Microbiol., 77, 1541-1547, doi: 10.1128/AEM.02766-10; Wilks, S. A., Michels, H., and Keevil, C. W. (2005), The survival of Escherichia coli O157 on a range of metal surfaces, Int. J. Food Microbiol. 105, 445-454, doi: 10.1016/j.ijfoodmicro.2005.04.021; and Noyce, J. O., Michels, H., and Keevil, C. W. (2006), Potential use of copper surfaces to reduce survival of epidemic meticillin-resistant Staphylococcus aureus in the healthcare environment, J. Hosp. Infect. 63, 289-297, doi: 10.1016/j.jhin.2005.12.008). Copper's antiviral, antibacterial, and antifungal effect is associated with various mechanisms, including damaging the pathogen nucleic acid and altering the membrane integrity (Reyes-Jara A., Cordero N., Aguirre J., Troncoso M., and Figueroa G. (2016), Antibacterial Effect of Copper on Microorganisms Isolated from Bovine Mastitis, Front. Microbiol. 7:626, doi: 10.3389/fmicb.2016.00626). In addition, copper has been recently registered at the U.S Environmental Protection Agency as the first solid antimicrobial material.

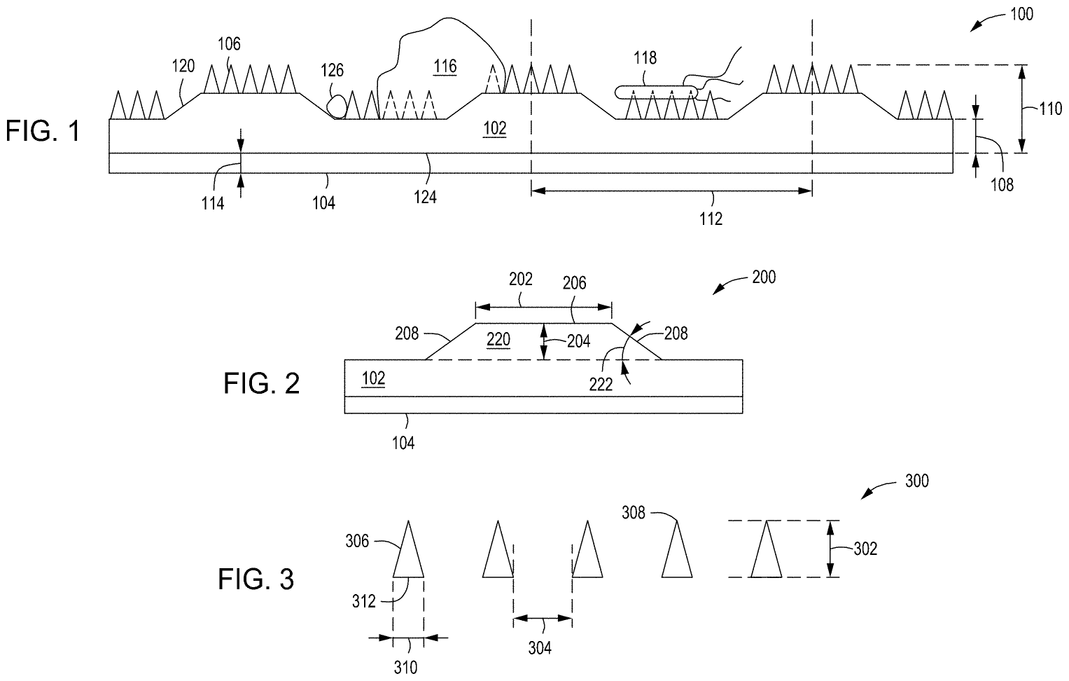

Even though copper may have a detrimental effect on bacteria and virus and the like, the copper must be in a cost-effective form to allow for widespread acceptance and distribution. The inventors have discovered that in order to have an effective antimicrobial film, the film should have at least three characteristics—have a hydrophobic surface, have tiny structures that can pierce or punch through a microbe membrane and/or virus envelope, and have the ability to incapacitate the microbe and/or virus (along with being able to be cost effectively manufactured). FIG. 1 depicts a cross-sectional view of an antimicrobial film 100 in accordance with some embodiments. The antimicrobial film 100 has a plurality of microstructures 120 that are formed into a polymer layer or polymer film 102. The polymer film 102 may include polypropylene, and/or polyethylene, and the like. The polymer film 102 may have a base thickness 108 of approximately 50 microns to approximately 200 microns. The base thickness is selected based on a desired flexibility while still maintaining structural integrity for the antimicrobial surface. For example, a thinner base material may provide the flexibility necessary for applying the polymer film 102 to a membrane keyboard and the like while a thicker base material would provide more support for the polymer film 102 when applied to large areas such as walls and floors and the like.

In some embodiments, an adhesive layer 104 is applied to a back surface 124 of the polymer film 102. In some embodiments, the adhesive layer 104 may be substantially thicker than the polymer film 102. The adhesive layer 104 may have a thickness 114 of approximately 100 microns to approximately 1000 microns. In some embodiments, the adhesive layer 104 may be applied as a single layer with a protective backing (not shown) which is peeled off to expose the adhesive layer 104 and apply the polymer film 102 to a surface. In some embodiments, the adhesive layer 104 may be sprayed onto the back surface 124 of the polymer film 102. The plurality of microstructures 120 create a hydrophobic surface on the antimicrobial film 100 that helps to bead up any droplets that fall on the polymer film surface. In some embodiments, the plurality of microstructures 120 have a spacing 112 of approximately 5 microns to approximately 20 microns. In some embodiments, the plurality of microstructures 120 have a spacing 112 of approximately 10 microns. In some embodiments, the total height 110 of the polymer film 102 including a plurality of nanostructures is approximately 75 microns to approximately 125 microns. In some embodiments, the total height 110 of the polymer film 102 including a plurality of nanostructures is approximately 100 microns.

The plurality of nanostructures such as, but not limited to, a plurality of nanospikes 106 are distributed on the surface of the polymer film 102 including on the plurality of microstructures 120. The term nanostructure as used herein is a structure with at least one dimension of 100 nm or less. The nanospikes 106 have an apex or top portion that is 100 nm or less (see, e.g., FIG. 3). The plurality of nanospikes 106 are configured to pierce or punch through a membrane of a microbe 118 or bacteria 116 or an envelope of a virus 126. The plurality of nanospikes 106 also effectively increases the surface area of the top of the polymer film 102, allowing more antimicrobial contact area to be formed. The increased contact area increases the chances that ultra-small viruses (e.g., 15 nm or less) will come into contact with the antimicrobial surface even if the virus is not pierced by the plurality of nanospikes 106. The plurality of nanospikes 106 and the surface of the polymer film 102 are coated, at an atomic level, with copper or other antimicrobial substances. The microbe 118, bacteria 116, and/or virus 126 also come into contact with the surface of the polymer film 102 which is also coated with copper or other antimicrobial substances.

When the microbe 118, bacteria 116, and/or the virus 126 comes into contact with the copper, the copper has free electrons which interact with the microbe 118, bacteria 116, and/or virus 126, causing an oxidation-reduction-reaction which kills the microbe 118, bacteria 116, and/or virus 126 in a relatively short amount of time (approximately 4 hours or less), effectively sanitizing any surface that the polymer film 102 is applied to. In some embodiments, the copper coating may be replaced with a copper oxide coating with similar anti-microbe and anti-virus effects. Moreover, even if the copper applied to the polymer film 102 becomes oxidized, the copper's antimicrobial effects will not be diminished. The methods and apparatus of the present principles may also be used with other coatings as well. For example, silver may be used but silver has a much higher cost than copper and requires much longer time to kill off bacteria, microbes, and viruses. However, any coating that is cost effective and provides a short lifespan for bacteria, microbes, and viruses when in contact, may be substituted for the copper without issues.

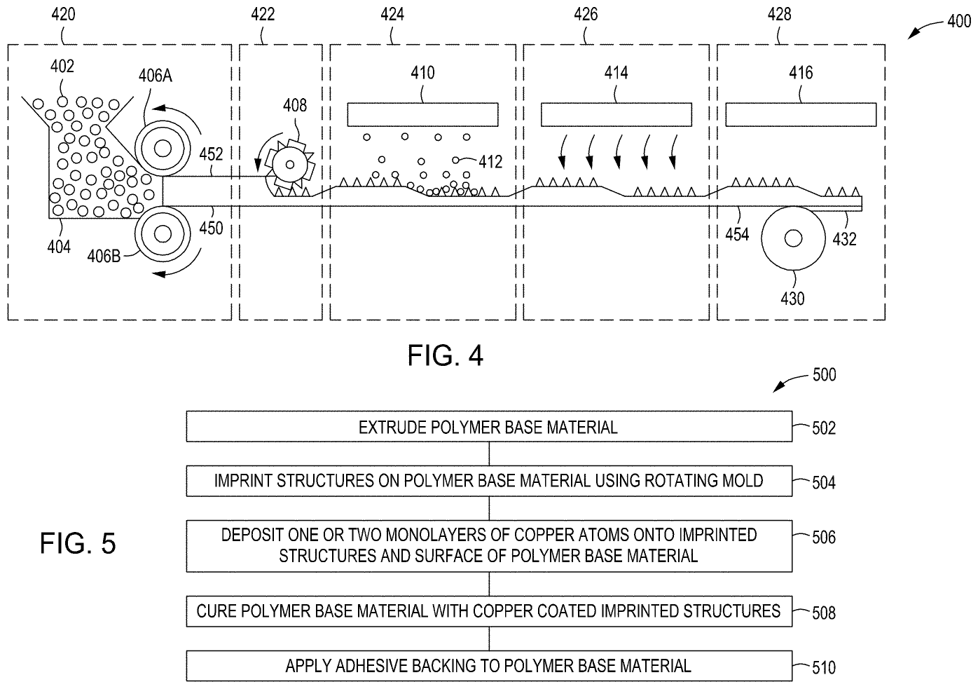

FIG. 2 depicts a cross-sectional view 200 of a microstructure 220 in accordance with some embodiments. The microstructure 220 is formed into the polymer film 102 as described below for FIGS. 4 and 5. In some embodiments, the microstructure 220 has a height 204 of approximately 5 microns to approximately 10 microns. In some embodiments, the microstructure 220 has a height 204 of approximately 8 microns. In some embodiments, the microstructure 220 has a top surface 206 with a width 202 of approximately 3 microns to approximately 8 microns. In some embodiments, the microstructure 220 has a top surface 206 with a width 202 of approximately 5 microns. The sloped surfaces 208 of the microstructure 220 may be at angle 222 of 90 degrees or less. Production costs can be reduced by using the sloped surfaces 208 which are easier to manufacturer and, therefore, less costly. In some embodiments, the polymer film 102 may have a variety of different sizes and densities (spacing 112) of the microstructures.

FIG. 3 depicts a cross-sectional view 300 of nanostructures 306 in accordance with some embodiments. The nanostructures 306 have a height 302 of approximately 0.3 microns to approximately 3.0 microns. In some embodiments, the nanostructures 306 have a height 302 of approximately 0.5 microns. A base 312 of the nanostructures 306 may have a width 310 of approximately 0.5 microns or less. The nanostructures 306 may have a spacing 304 of approximately 0.1 microns to approximately 1.0 microns. In some embodiments, the nanostructures 306 may have a spacing 304 of approximately 0.5 microns. In some embodiments, the polymer film 102 may have a variety of different shapes, sizes, and densities (spacing 304) of the nanostructures 306. An apex or top portion 308 of the nanostructures 306 is configured to punch through or pierce a membrane of a microbe and/or an envelope of a virus. As such, and due to the nano size of the nanostructures 306, the apex or top portion 308 may or may not visually appear as a sharp point as depicted in FIG. 3. The apex or top portion 308 is approximately 100 nm or less. The shape is only relevant as to the nanostructure's ability to punch through or pierce into the membrane of the microbe or bacteria and/or the envelope of the virus. One skilled in the art can appreciate that other top portions 308 may be used that have sufficient capabilities to enter the microbe and/or virus (e.g., multiple points on a single nanostructure, etc.).

The inventors have found that the copper coated structures and surface of the polymer film 102 creates a hydrophobic surface inhibiting the adhesion of microbes and providing water scarcity in the microbe's microenvironment. The nanostructures (nanospikes) punch/pierce into the microbe membrane and/or virus envelope to bring the copper coating into direct contact with the bacteria inner membrane and/or virus envelope. The copper has a free electron in the copper atom's outer orbital shell of electrons that easily takes part in oxidation-reduction reactions. When a microbe lands on the copper, ions create free radicals that inactivate the microbe, especially on dry surfaces (see, Reyes-Jara et al., 2016, infra). The antimicrobial film of the present principles may be applied to surfaces such as, but not limited to, walls, seats, packaging, fabric, doors, counters, and other high touch surfaces. In addition, the antimicrobial film may also be used in bandages, gauze wraps, and the like to further protect wounds and sensitive areas and the like. The antimicrobial film may last months to even years before becoming ineffective.

The inventors have also found that the antimicrobial film may be fabricated by combining three technologies, blow extrusion, thermal nanoimprint lithography, and low temperature atomic layer/chemical vapor deposition in a roll-to-roll process as illustrated below in FIG. 4. The stock materials of Polypropylene (PP), Polyethylene (PE) can be formed into thin films (˜100 micrometers thick) by blow extrusion. The nano and micro scale structures can then be imprinted onto the film surface by thermal nanoimprint lithography using a nickel-based mold with a pre-designed nano and micro scale features in a continuous roll-to-roll process. Low temperature atomic layer or chemical vapor deposition can be used to deposit a sub-monolayer of copper atoms on the micro and nano structured surface.

FIG. 4 depicts a cross-sectional view of a roll-to-roll production system 400 for producing antimicrobial film in accordance with some embodiments. The roll-to-roll production system 400 provides a cost-effective process for manufacturing antimicrobial polymer films. In a first stage 420, polymer granules 402 are fed into a hopper 404. The polymer granules 402 are then forced into rollers 406A, 406B of a blow extrusion machine to produce a polymer film 450. In a second stage 422, a rotating imprint roller 408 has a nickel-based mold attached that forms microstructures and nanostructures (e.g., nanospikes, etc.) into a top surface 452 of the polymer film 450. In a third stage 424, a deposition chamber 410 is used for a low temperature atomic layer deposition (ALD) and/or chemical vapor deposition (CVD) process to deposit one or two monolayers of copper atoms 412 on the top surface 452 of the polymer film 450 including the surfaces of the microstructures and nanostructures.

In a fourth stage 426, a curing chamber 414 is used to cure the polymer film 450. In some embodiments, ultraviolet (UV) light is used to cure the polymer film 450. In some embodiments, heat sources or microwave sources may be used to cure the polymer film 450. In some embodiments, in a fifth stage 428, an adhesive applicator 416 applies adhesive film 432 to a bottom surface 454 of the polymer film 450 by a roller 430. In some embodiments, the adhesive film 432 may have a protective film that may be peeled off by a subsequent user prior to applying to a surface that needs to be kept sterile. In some embodiments, the adhesive applicator 416 uses a spray process to apply adhesive film 432 to the bottom surface 454 of the polymer film 450. A protective film may be applied on the adhesive after the adhesive is sprayed onto the bottom surface 454 of the polymer film 450. All stages may be applied to a continuous polymer film layer. That is, as the polymer film is formed, the polymer film travels through each of the stages without being cut or separated into multiple pieces. The continuous polymer film may be formed to any length necessary to create any size of antimicrobial film in a cost-effective manner.

FIG. 5 is a method 500 of producing antimicrobial film in accordance with some embodiments. In block 502, polymer in a basic form (such as polymer granules) are extruded to form a polymer base material. In block 504, structures are imprinted on the polymer base material using a rotating mold such as a nickel mold. In block 506, one or two monolayers of copper atoms or other antimicrobial substances are deposited onto the structures and the surface of the polymer base material. In some embodiments, an ALD/CVD process may be used for the deposition of the copper atoms or other antimicrobial substances. In block 508, the polymer base material with the antimicrobial coated, imprinted structures is cured. In some embodiments, the curing process uses ultraviolet (UV) to cure the polymer base material. In some embodiments, the curing process uses microwaves or heat to cure the polymer base material.

In block 510, an adhesive backing is applied to polymer base material. In some embodiments, the adhesive backing is an adhesive layer that is applied to a bottom surface of the polymer base material and, in some embodiments, the adhesive is sprayed onto the bottom surface of the polymer base material. In some embodiments, the adhesive thickness may be substantially greater than the thickness of the polymer base material. The flexibility of the polymer base material may be altered based on different uses. For example, if the antimicrobial film is to be used on large surfaces, a stiffer adhesive backing may be used to allow more support for easier coverage of large areas. If the antimicrobial film is to be used on flexible surfaces, the adhesive backing may be much thinner to allow for greater flexibility of the antimicrobial film.

Embodiments in accordance with the present principles may be implemented in hardware, firmware, software, or any combination thereof. Embodiments may also be implemented as instructions stored using one or more computer readable media, which may be read and executed by one or more processors. A computer readable medium may include any mechanism for storing or transmitting information in a form readable by a machine (e.g., a computing platform or a “virtual machine” running on one or more computing platforms). For example, a computer readable medium may include any suitable form of volatile or non-volatile memory. In some embodiments, the computer readable media may include a non-transitory computer readable medium.

While the foregoing is directed to embodiments of the present principles, other and further embodiments of the principles may be devised without departing from the basic scope thereof.

1. An antimicrobial film, comprising:
a polymer layer having a first side and second side, wherein the first side of the polymer layer includes at least one microstructure and at least one nanostructure on the at least one microstructure; and
an antimicrobial coating on the at least one microstructure and the at least one nanostructure.

2. The antimicrobial film of claim 1, wherein the antimicrobial coating is formed of copper.

3. The antimicrobial film of claim 2, wherein the antimicrobial coating has a thickness of one or two monolayers of copper atoms.

4. The antimicrobial film of claim 1, further comprising:
an adhesive layer applied to the second side of the polymer layer.

5. The antimicrobial film of claim 4, wherein a thickness of the adhesive layer is greater than a thickness of the polymer layer.

6. The antimicrobial film of claim 1, wherein the polymer layer is formed from polypropylene or polyethylene.

7. The antimicrobial film of claim 1, wherein the at least one microstructure has a height of approximately 5 microns to approximately 10 microns above a first top surface of the first side of the polymer layer.

8. The antimicrobial film of claim 1, wherein a second top surface of the at least one microstructure has a width of approximately 3 microns to 8 microns.

9. The antimicrobial film of claim 1, wherein the at least one microstructure has a height of approximately 0.3 microns to approximately 3.0 microns above a first top surface of the first side of the polymer layer and a second top surface of the at least one microstructure has a width of approximately 5 microns.

10. The antimicrobial film of claim 1, wherein the at least one nanostructure has a height of approximately 0.3 microns to approximately 3.0 microns above a second top surface of the at least one microstructure with an apex of approximately 100 nm or less.

11. The antimicrobial film of claim 1, wherein a spacing between two or more of the at least one nanostructure is approximately 0.1 microns to approximately 1.0 microns.

12. The antimicrobial film of claim 1, wherein the at least one nanostructure has a height of approximately 0.3 microns to approximately 3.0 microns above a second top surface of the at least one microstructure and a spacing between two or more of the at least one nanostructure is approximately 0.5 microns.

13. The antimicrobial film of claim 1, wherein the antimicrobial film is hydrophobic.

14. A system for forming antimicrobial film, comprising:
an extruder configured to form a polymer film from polymer granules;
a mold configured to imprint at least one microstructure and at least one nanostructure on a top surface of the polymer film after the polymer film is formed by the extruder;
a deposition chamber configured to form an antimicrobial coating on the top surface of the polymer film, the at least one microstructure, and the at least one nanostructure; and
a curing chamber configured to cure the polymer film.

15. The system of claim 14, further comprising:
an adhesive applicator configured to form adhesive on a bottom surface of the polymer film.

16. The system of claim 14, wherein the antimicrobial coating is formed by deposition of one or two monolayers of copper atoms.

17. The system of claim 14, wherein the curing chamber is configured to use ultraviolet light to cure the polymer film.

18. A method of forming antimicrobial film, comprising:
extruding granules of a polymer material to form a polymer base material;
imprinting at least one structure on a top surface of the polymer base material using a rotating mold, wherein the at least one structure is a microstructure or a nanostructure;
depositing an antimicrobial coating onto the at least one structure and the top surface of the polymer base material; and
curing the polymer base material to form an antimicrobial film.

19. The method of claim 18, further comprising:
applying an adhesive to a bottom surface of the polymer base material.

20. The method of claim 18, wherein the antimicrobial coating consists of copper material.
